(19) United States
(12) Patent Application Publication
(10) Pub. No.: US 2011/0180518 A1
(43) Pub. Date: Jul. 28, 2011

(54) RESISTANCE WELDING METHOD

(75) Inventors: Eisaku HASEGAWA, Kanuma-shi (JP); Yushi AOKI, Utsunomiya-shi (JP); Mitsugu KANEKO, Utsunomiya-shi (JP); Taku MAKITA, Utsunomiya-shi (JP); Katsumi TAKEISHI, Fujimino-shi (JP)

(73) Assignee: HONDA MOTOR CO., LTD., Tokyo (JP)

(21) Appl. No.: 13/014,378

(22) Filed: Jan. 26, 2011

(30) Foreign Application Priority Data
Jan. 28, 2010 (JP) 2010-016095

(51) Int. Cl. B23K 11/25; B23K 11/00

(52) U.S. Cl. 219/108; 219/78.01

(57) ABSTRACT

A resistance welding method, which resistance-welds a pair of workpieces by gripping the workpieces with a pair of electrode tips under a prescribed welding pressure, and supplies a welding current through the electrode tips to the workpieces, includes the steps of detecting a change in an amount of expansion of a nugget produced in the workpieces, along a direction in which the electrode tips grip the workpieces therebetween, determining whether the detected change is smaller than a threshold value or not, and gradually increasing the welding current flowing through the workpieces after the detected change is judged as being smaller than the threshold value.

### CROSS-REFERENCE TO RELATED APPLICATION

This application is based upon and claims the benefit of priority from Japanese Patent Application No. 2010-016095 filed on Jan. 28, 2010, of which the contents are incorporated herein by reference.

### BACKGROUND OF THE INVENTION

1. Field of the Invention

The present invention relates to a resistance welding method for resistance-welding workpieces efficiently by controlling a welding pressure applied to the workpieces and a welding current passing through the workpieces.

2. Description of the Related Art

As disclosed in Japanese Laid-Open Patent Publication No. 04-178274, there has heretofore been known a technical concept about a resistance welding process wherein while electrode tips held in contact with workpieces to be welded are being energized, a high current is initially supplied to the workpieces, and then a reduced current is supplied to the workpieces at the time a nugget starts to be formed in the workpieces, followed by a progressively increased current supplied to the workpiece subsequent to a middle stage of the resistance welding process, thereby forming a large-volume nugget in the workpieces without causing substantial sputtering.

However, it is unclear from the technical concept disclosed in Japanese Laid-Open Patent Publication No. 04-178274 as to the time at which the current should start to be progressively increased. Dependent on the time when the current starts to be progressively increased, sputtering may occur tending to impede the growth of the nugget.

### SUMMARY OF THE INVENTION

It is an object of the present invention to provide a resistance welding method which minimizes the occurrence of sputtering to promote the growth of a nugget.

To achieve the above object, there is provided in accordance with the present invention a method of resistance-welding a pair of workpieces by gripping the workpieces with a pair of electrode tips under a prescribed welding pressure, and supplying a welding current through the electrode tips to the workpieces, comprising the steps of detecting a change in an amount of expansion of a nugget produced in the workpieces, along a direction in which the electrode tips grip the workpieces therebetween, determining whether the detected change is smaller than a threshold value or not, and gradually increasing the welding current flowing through the workpieces after the detected change is judged as being smaller than the threshold value.

The step of gradually increasing the welding current may comprise the step of increasing the welding current depending on the detected change.

The method may further comprise the step of lowering the welding pressure applied to the workpieces after the detected change is judged as being smaller than the threshold value.

To achieve the above object, there is also provided in accordance with the present invention a method of resistance-welding a pair of workpieces by gripping the workpieces with a pair of electrode tips under a prescribed welding pressure, and supplying a welding current through the electrode tips to the workpieces, comprising the steps of detecting a change in an amount of expansion of a nugget produced in the workpieces, along a direction in which the electrode tips grip the workpieces therebetween, determining whether the detected change is smaller than a threshold value or not, and lowering the welding pressure applied to the workpieces after the detected change is judged as being smaller than the threshold value.

According to the present invention, in a resistance welding process, a change in the amount of expansion of the nugget produced in and between the workpieces is detected along the direction in which the electrode tips grip the workpieces. After the detected change is judged as being smaller than the threshold value, the welding current flowing through the workpieces is gradually increased. Therefore, while the nugget is quickly growing along the direction in which the electrode tips grip the workpieces, the welding current is relatively small to prevent sputtering from developing. While the nugget is not quickly growing, i.e., while an amount of heat generated by the resistance welding process is increasing, the welding current is increased to promote the growth of the nugget, and the time in which the workpieces are resistance-welded, i.e., the welding time, is shortened without significantly causing sputtering.

According to the present invention, furthermore, in a resistance welding process, a change in the amount of expansion of the nugget produced in and between the workpieces is detected along the direction in which the electrode tips grip the workpieces. After the detected change is judged as being smaller than the threshold value, the welding pressure applied to the workpieces is lowered. Therefore, while the nugget is quickly growing along the direction in which the electrode tips grip the workpieces, the workpieces are pressed under a high welding pressure to minimize sputtering. While the nugget is not quickly growing, i.e., while an amount of heat generated by the resistance welding process is increasing, the welding pressure applied to the workpieces is lowered, resulting in an increase in the contact resistance between the workpieces and the electrode tips. Consequently, the growth of the nugget is promoted, reducing the welding time without significantly causing sputtering.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a resistance welding apparatus which carries out a resistance welding method according to the present invention;

FIG. 2 is an enlarged fragmentary elevational view, partly in cross section, showing the manner in which a pair of workpieces to be welded are gripped by a pair of electrode tips and a nugget is grown in the workpieces;

FIG. 3 is a flowchart of an operation sequence of the resistance welding apparatus shown in FIG. 1;

FIGS. 4A through 4D are graphs showing the relationships between an amount of expansion of the nugget along the direction in which the electrode tips grip the workpieces, a welding pressure, a welding current, and a contact area of the electrode tip, and the time; and

FIG. 5 is a graph showing the relationship between a change in the amount of expansion of the nugget along the direction in which the electrode tips grip the workpieces, and the time.

### DESCRIPTION OF THE PREFERRED EMBODIMENTS

A resistance welding method according to a preferred embodiment of the present invention in relation to a resistance welding apparatus which carries out the resistance welding method will be described in detail below with reference to the accompanying drawings.

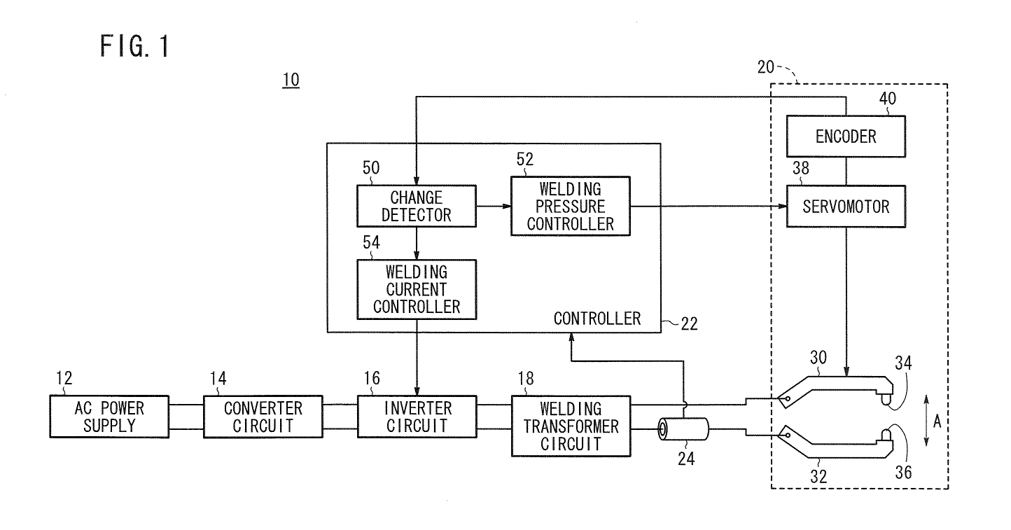

FIG. 1 is a block diagram of a resistance welding apparatus 10 according to an embodiment of the present invention. As shown in FIG. 1, the resistance welding apparatus 10 comprises a converter circuit 14 for converting an alternating current output from an AC power supply 12 into a direct current, an inverter circuit 16 for converting the direct current into a high-frequency alternating current, a welding transformer circuit 18 for transforming and rectifying the high-frequency alternating current, a welding gun assembly 20 for gripping a pair of workpieces, a controller 22 for controlling a welding current which passes through the workpieces and a welding pressure applied to the workpieces, and a current detector 24 for detecting the welding current which passes through the workpieces.

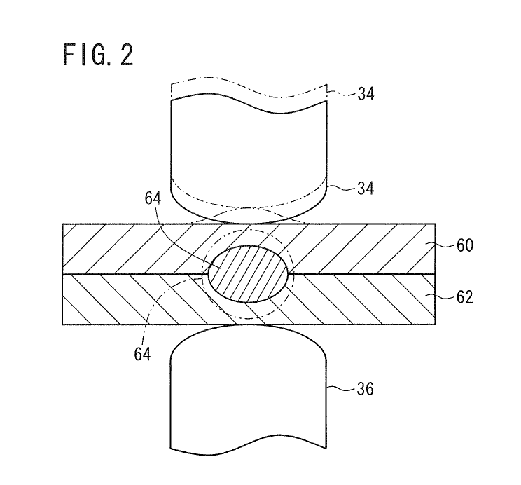

The welding gun assembly 20 comprises a movable gun arm 30 and a fixed gun arm 32 for jointly gripping the workpieces, a pair of electrode tips 34, 36 securely mounted respectively on the movable gun arm 30 and the fixed gun arm 32, a servomotor 38 for moving the movable gun arm 30 along the direction indicated by the arrow A in which the movable gun arm 30 and the fixed gun arm 32 grip the workpieces, and an encoder (amount-of-expansion detector) 40 for detecting an amount of expansion of a nugget grown in the workpieces along the direction in which the workpieces are gripped when the workpieces are resistance-welded. The workpieces to be resistance-welded are placed between the electrode tips 34, 36. The nugget refers to a region of the workpieces which has been melted and coagulated by Joule heat generated when the welding current passes through the electrode tips 34, 36 and hence the workpieces 60, 62. In FIG. 2, the workpieces are denoted by the respective reference numerals 60, 62, and the nugget by the reference numeral 64.

A displacing mechanism such as a ball screw or the like, not shown, is connected to the movable gun arm 30 and also to the servomotor 38. When the servomotor 38 is energized to rotate its output shaft in one direction, the displacing mechanism is actuated to move the movable gun arm 30 toward the fixed gun arm 32 to grip the workpieces 60, 62 that are placed therebetween. The workpieces 60, 62 can thus be gripped under a desired welding pressure by the movable gun arm 30 and the fixed gun arm 32. The encoder 40 detects the displacement of the movable gun arm 30 toward or away from the fixed gun arm 32, i.e., the displacement of the electrode tip 34 toward or away from the electrode tip 36. The displaced position of the movable gun arm 30, i.e., the electrode tip 34, which is detected by the encoder 40 serves as an amount of expansion of the nugget 64 along the direction in which the electrode tips 34, 36 grip the workpieces 60, 62 therebetween. The direction in which the electrode tips 34, 36 grip the workpieces 60, 62 therebetween will hereinafter referred to as “gripping direction”.

When the nugget 64 is vertically expanded by the Joule heat as indicated by the two-dot-and-dash lines in FIG. 2, the workpiece 60 which is positioned upwardly of the nugget 64 is partly expanded upwardly, causing the electrode tip 34 to move upwardly, as indicated by the dot-and-dash lines in FIG. 2. As a result, the movable gun arm 30 is lifted in the direction indicated by the arrow A. The upward displacement of the movable gun arm 30, which represents the amount of expansion of the nugget 64, is detected by the encoder 40. Specifically, as the movable gun arm 30 is lifted in the direction indicated by the arrow A, the ball screw as the displacement mechanism is lifted, rotating the servomotor 38. The encoder 40 detects the rotation of the servomotor 38 to detect the amount of expansion of the nugget 64 along the gripping direction.

The controller 22 comprises a change detector 50 for detecting a change in the amount of expansion of the nugget 64 along the gripping direction, a welding pressure controller 52 for controlling the welding pressure applied to the workpieces 60, 62 based on the detected change in the amount of expansion of the nugget 64, and a welding current controller 54 for controlling the welding current passing through the workpieces 60, 62 based on the detected change in the amount of expansion of the nugget 64.

The change detector 50 periodically detects a change in the amount of expansion of the nugget 64 in the gripping direction based on amounts of expansion of the nugget 64 in the gripping direction which are detected at different times. A change in the amount of expansion of the nugget 64 in the gripping direction represents a rate of growth of the nugget 64 in the gripping direction. For example, the change detector 50 periodically detects a change in the amount of expansion of the nugget 64 in the gripping direction based on an amount of expansion of the nugget 64 in the gripping direction which is detected in a present cycle and an amount expansion of the nugget 64 in the gripping direction which is detected in a preceding cycle.

The welding pressure controller 52 controls the servomotor 38 to displace the ball screw (not shown) for thereby controlling the welding pressure applied for the electrode tips 34, 36 to grip the workpieces 60, 62. The welding current controller 54 controls the inverter circuit 16 according to a PWM process to control the welding current which passes through the workpieces 60, 62. The controller 22 comprises a computer, not shown. The computer functions as the controller 22 when the computer reads and executes a corresponding program. According to the present embodiment, the controller 22 controls the welding current flowing through the electrode tips 34, 36 according to a feedback control process, based on the welding current detected by the current detector 24.

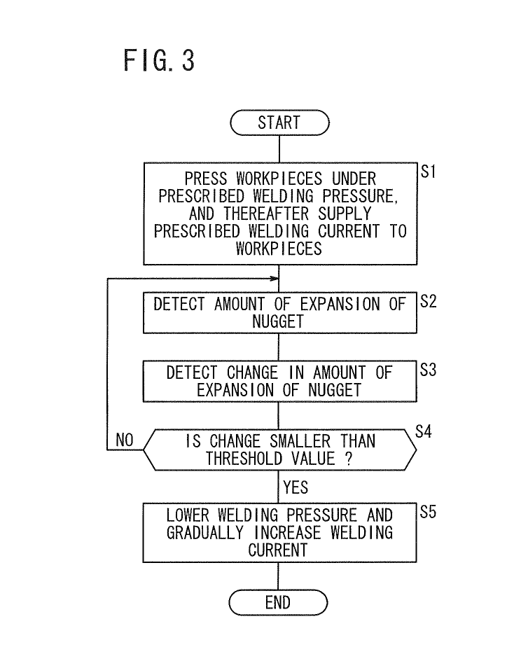

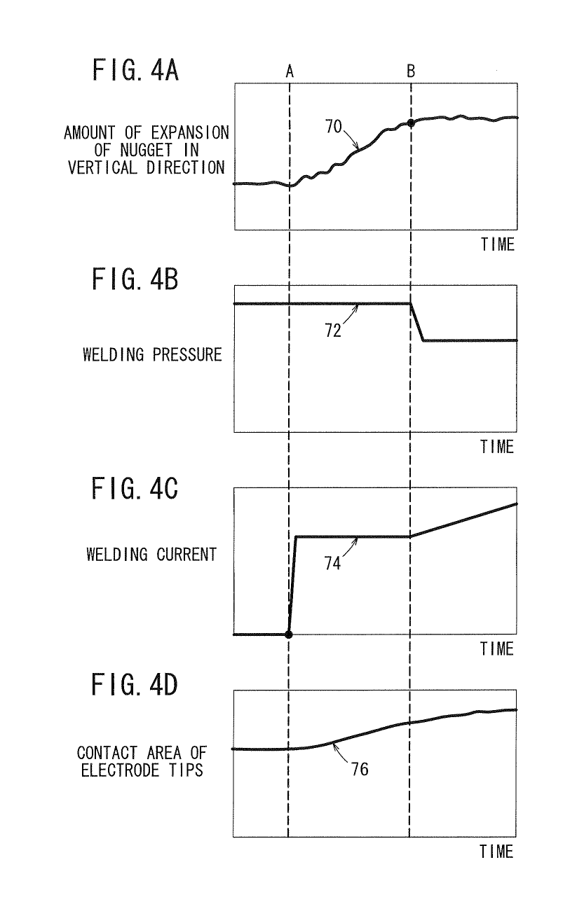

Operation of the resistance welding apparatus 10 will be described below with reference to a flowchart shown in FIG. 3 and graphs shown in FIGS. 4A through 4D. FIGS. 4A through 4D are graphs showing the relationships between the amount of expansion of the nugget 64 along the gripping direction (hereinafter referred to as “vertical direction of the nugget 64”), the welding pressure, the welding current, and a contact area of the electrode tips 34, 36 held in contact with the workpieces 60, 62, and the time. Specifically, the graph shown in FIG. 4A illustrates a curve 70 representative of the relationship between the amount of expansion of the nugget 64 along the vertical direction of the nugget 64 and the time. The graph shown in FIG. 4B illustrates a curve 72 representative of the relationship between the welding pressure and the time. The graph shown in FIG. 4C illustrates a curve 74 representative of the relationship between the welding current and the time. The graph shown in FIG. 4D illustrates a curve 76 representative of the relationship between the contact area of the electrode tips 34, 36 held in contact with the workpieces 60, 62 and the time.

The welding pressure controller 52 controls the servomotor 38 to cause the electrode tips 34, 36 to grip and press the workpieces 60, 62 under a prescribed welding pressure. Thereafter, the welding current controller 54 supplies a prescribed welding current through the electrode tips 34, 36 to the workpieces 60, 62 in step S1 shown in FIG. 3.

In FIGS. 4A through 4D, timing A represents the time at which the welding current controller 54 starts to supply the welding current through the electrode tips 34, 36 to the workpieces 60, 62. In an initial stage of the supply of the welding current, the nugget 64 produced in the workpieces 60, 62 quickly grows vertically in the direction indicated by the arrow A. Therefore, the internal pressure between the workpieces 60, 62 quickly rises and tends to cause sputtering. In the initial stage of the supply of the welding current, furthermore, since the contact area of the electrode tips 34, 36 held in contact with the workpieces 60, 62, i.e., the pressing area in which electrode tips 34, 36 press the workpieces 60, 62, is relatively small as indicated by the curve 76 shown in FIG. 4D, the nugget 64 is not sufficiently held and confined in position. According to the present embodiment, the welding pressure controller 52 presses the workpieces 60, 62 under a relatively high welding pressure as the prescribed pressure (see the curve 72 in FIG. 4B), thereby holding the nugget 64 in position and preventing sputtering from developing.

In the initial stage of the supply of the welding current, moreover, the electric resistance between the electrode tips 34, 36 is relatively large. If the welding current controller 54 supplies a large welding current through the electrode tips 34, 36 to the workpieces 60, 62, then the growth of the nugget 64 in the vertical direction tends to increase, i.e., the internal pressure between the workpieces 60, 62 tends to increase, making it more likely for sputtering to develop. According to the present embodiment, the welding current controller 54 supplies the workpieces 60, 62 with a welding current small enough to prevent sputtering from developing (see the curve 74 in FIG. 4C). As more time elapses in the resistance welding process, the contact area of the electrode tips 34, 36 held in contact with the workpieces 60, 62 gradually increases (see the curve 76 in FIG. 4D).

When the welding current passes through the workpieces 60, 62, the nugget 64 is produced in and between the workpieces 60, 62, as shown in FIG. 2.

After step S1 in FIG. 3, the encoder 40 detects an amount of expansion of the nugget 64 along the vertical direction in step S2. As described above, when the nugget 64 is vertically expanded by the Joule heat as indicated by the two-dot-and-dash lines in FIG. 2, part of the workpiece 60 which is positioned upwardly of the nugget 64 is expanded upwardly, causing the electrode tip 34 to move upwardly, as indicated by the dot-and-dash lines in FIG. 2. As a result, the movable gun arm 30 is lifted in the direction indicated by the arrow A. The upward displacement of the movable gun arm 30, which represents the amount of expansion of the nugget 64, is detected by the encoder 40.

Then, in step S3, the change detector 50 detects a change in the amount of expansion of the nugget 64 based on the amount of expansion of the nugget 64 which was detected in step S2. Specifically, the change detector 50 detects a change in the amount of expansion of the nugget 64 based on an amount expansion of the nugget 64 in the vertical direction which is detected in a present cycle and an amount expansion of the nugget 64 in the vertical direction which is detected in a preceding cycle.

Then, the welding pressure controller 52 and the welding current controller 54 determine whether the change detected in step S3 is smaller than a threshold value or not in step S4. In the initial stage of the supply of the welding current, the nugget 64 produced in the workpieces 60, 62 quickly grows vertically, as described above, and hence the change in the amount of expansion of the nugget 64 in the vertical direction is relatively large. As the time in which the welding current is supplied elapses, i.e., as the welding time elapses, the growth of the nugget 64 becomes greater in the horizontal direction than in the vertical direction. Therefore, the change in the amount of expansion of the nugget 64 in the vertical direction becomes smaller as the welding time goes by (see the curve 70 in FIG. 4A).

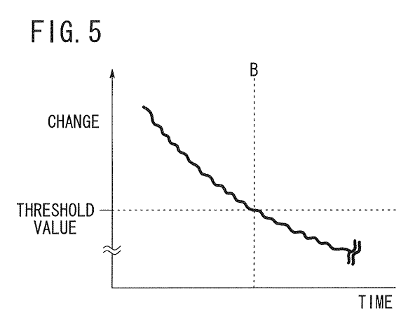

FIG. 5 is a graph showing the relationship between the change in the amount of expansion of the nugget 64 in the vertical direction, and the time. In FIGS. 4A through 4D and 5, timing B represents the time at which the change in the amount of expansion of the nugget 64 starts to be judged as being smaller than the threshold value.

The threshold value may be a value which is a certain percentage smaller than the maximum one of detected changes, and may vary depending on the material of the workpieces 60, 62. For example, if the workpieces 60, 62 are made of a high-strength material and each has a thickness of 1.6 mm, then the threshold value may be a value which is 30% smaller than the maximum detected change.

If the change is judged as being not smaller than the threshold value in step S4, then control goes back to step S2 to repeat steps S2, S3, and S4. Consequently, the change detector 50 periodically detects a change in the amount of expansion of the nugget 64 in the gripping direction until it is judged that a change in the amount of expansion of the nugget 64 is smaller than the threshold value. Changes that are periodically detected at corresponding timings by the change detector 50 represent respective gradients of the curve 70 in FIG. 4A at the corresponding timings. Therefore, the change detector 50 periodically detects the gradients of the curve 70 in FIG. 4A.

If the change is judged as being smaller than the threshold value in step S4, then control goes to step S5 in which the welding pressure controller 52 gradually lower the welding pressure, and the welding current controller 54 gradually increases the welding current. As seen from the curve 72 in FIG. 4B, the prescribed welding pressure is applied to the workpieces 60, 62 until the welding time reaches the timing B. When the welding time reaches the timing B, the welding pressure is lowered from the prescribed welding pressure to a certain pressure level, and is subsequently maintained at the certain pressure level. As seen from the curve 74 in FIG. 4C, the prescribed welding current is supplied to the workpieces 60, 62 until the welding time reaches the timing B. When the welding time reaches the timing B, the welding current is gradually increased from the prescribed welding current.

The welding current may be maintained at a certain current after the welding current has been increased to the certain current. The welding current may be increased at a rate which varies depending on the detected change in the amount of expansion of the nugget 64. For example, the rate at which the welding current is increased may be increased as the detected change in the amount of expansion of the nugget 64 is reduced.

Reasons why the welding pressure is lowered and the welding current is increased when the detected change in the amount of expansion of the nugget 64 is judged as being smaller than the threshold value in step S4, will be described below. As described above, in the initial stage of the supply of the welding current, the nugget 64 produced in the workpieces 60, 62 quickly grows vertically. In middle and later stages of the supply of the welding current, the nugget 64 grows mainly in the horizontal direction. In other words, while the nugget 64 grows mainly in the horizontal direction, the nugget 64 does not grow significantly in the vertical direction, and hence any change in the amount of expansion of the nugget 64 in the vertical direction is small and sputtering is less liable to develop.

In the middle and later stages of the supply of the welding current, since the contact area of the electrode tips 34, 36 held in contact with the workpieces 60, 62 is increased, the amount of heat generated by the resistant welding process is radiated through the electrode tips 34, 36, lowering the heating efficiency between the workpieces 60, 62 and slowing the growth of the nugget 64. Inasmuch as the amount of heat generated by the resistant welding process is radiated also through the workpieces 60, 62, the growth of the nugget 64 is further slowed.

According to the present embodiment, when the change in the amount of expansion of the nugget 64 in the vertical direction becomes smaller than the threshold value, the welding pressure applied to the workpieces 60, 62 is lowered, increasing the contact resistance between the electrode tips 34, 36 and the workpieces 60, 62 and hence increasing the amount of heat generated by the resistant welding process. At the same time, the welding current supplied to the workpieces 60, 62 is increased to increase the amount of heat generated by the resistant welding process. Sputtering is less liable to develop in the middle and later stages of the supply of the welding current even when the welding pressure is lowered and the welding current is increased.

Therefore, the growth of the nugget 64 is promoted, and the time in which the welding current is supplied is reduced without significantly causing sputtering. Since the time in which an energy loss occurs during the resistance welding process is shortened because the time in which the welding current is supplied is reduced, the resistance welding method carried out by the resistance welding apparatus 10 is an energy saver. In the initial stage of the supply of the welding current, the internal pressure between the workpieces 60, 62 can be controlled to prevent sputtering from occurring by increasing the welding pressure and reducing the welding current.

The above embodiment of the present invention may be modified as described below.

(1) In the above embodiment, the servomotor 38 is used to move the movable gun arm 30. However, a linear actuator such as a fluid pressure cylinder or the like may be used instead of the servomotor 38 to actuate the movable gun arm 30 along the gripping direction of the workpieces 60, 62. In the above embodiment, only the movable gun arm 30 is actuated. However, both the gun arms 30, 32 may be movable gun arms that are movable in the gripping direction to control the pressure applied to the workpieces 60, 62. In the above embodiment, the encoder 40 is used to detect an amount of expansion of the nugget 64 in the vertical direction. However, a laser displacement sensor, a pressurization sensor, an ultrasonic detector, or the like may be used instead of the encoder 40 to detect an amount of expansion of the nugget 64 in the vertical direction.

(2) In the above embodiment, a change in the amount of expansion of the nugget 64 in the vertical direction is detected in step S3 in FIG. 3, and the detected change is compared with the threshold value to determine whether the detected change is smaller than the threshold value or not in step S4. However, control may go from step S2 directly to step S4, from which control may go to step S5 if the amount of expansion of the nugget 64 which was detected in step S3 is judged as being greater than a threshold value in step S4. In this modification, the threshold value used in step S4 is determined depending on the material of the workpieces 60, 62.

(3) In the above embodiment, both the welding current and the welding pressure are controlled to promote the growth of the nugget 64 to reduce the time in which the welding current is supplied without significantly causing sputtering. However, one of the welding current and the welding pressure may be controlled to promote the growth of the nugget 64 to reduce the time in which the welding current is supplied without significantly causing sputtering. For example, if the change in the amount of expansion of the nugget 64 in the vertical direction is judged as being smaller than the threshold value in step S4, then only the welding pressure applied to the workpieces 60, 62 may be reduced or only the welding current flowing through the workpieces 60, 62 may be increased in step S5.

(4) In the above embodiment, control goes directly to step S5 if the change in the amount of expansion of the nugget 64 in the vertical direction is judged as being smaller than the threshold value in step S4. However, control may go back from step S4 to step S2 until it is judged a predetermined number of times in step S4 that the change in the amount of expansion of the nugget 64 in the vertical direction is judged as being smaller than the threshold value, and control may go from step S4 to step S5 if it is judged the predetermined number of times in step S4 that the change in the amount of expansion of the nugget 64 in the vertical direction is judged as being smaller than the threshold value. According to this modification, control is prevented from going to step S5 when a change in the amount of expansion of the nugget 64 in the vertical direction is detected in error. Consequently, the growth of the nugget 64 is promoted more accurately and efficiently, reducing the time in which the welding current is supplied without significantly causing sputtering.

(5) The above modifications (1) through (4) may be combined in any desired patterns.

Although certain preferred embodiments of the present invention have been shown and described in detail, it should be understood that various changes and modifications may be made therein without departing from the scope of the appended claims.

What is claimed is:

1. A method of resistance-welding a pair of workpieces by gripping the workpieces with a pair of electrode tips under a prescribed welding pressure, and supplying a welding current through the electrode tips to the workpieces, comprising the steps of:
detecting a change in an amount of expansion of a nugget produced in the workpieces, along a direction in which the electrode tips grip the workpieces therebetween;
determining whether the detected change is smaller than a threshold value or not; and
gradually increasing the welding current flowing through the workpieces after the detected change is judged as being smaller than the threshold value.

2. The method according to claim 1, wherein the step of gradually increasing the welding current comprises the step of increasing the welding current depending on the detected change.

3. The method according to claim 1, further comprising the step of lowering the welding pressure applied to the workpieces after the detected change is judged as being smaller than the threshold value.

4. A method of resistance-welding a pair of workpieces by gripping the workpieces with a pair of electrode tips under a prescribed welding pressure, and supplying a welding current through the electrode tips to the workpieces, comprising the steps of:
detecting a change in an amount of expansion of a nugget produced in the workpieces, along a direction in which the electrode tips grip the workpieces therebetween;
determining whether the detected change is smaller than a threshold value or not; and
lowering the welding pressure applied to the workpieces after the detected change is judged as being smaller than the threshold value.
